(19) United States
(12) Patent Application Publication
(10) Pub. No.: US 2007/0088622 A1
(43) Pub. Date: Apr. 19, 2007

(54) DIGITAL MEDIA COMMERCE IN A PEER-TO-PEER NETWORK

(75) Inventor: Joel L. Floyd, San Francisco, CA (US)

Correspondence Address: INTELLECTUAL PROPERTY LAW OFFICES, 1901 S. BASCOM AVENUE, SUITE 660, CAMPBELL, CA, 95008, US

(73) Assignee: TAMAGO, Belmont, CA (US)

(21) Appl. No.: 11/538,768

(22) Filed: Oct. 4, 2006

Related U.S. Application Data
(60) Provisional application No. 60/723,423, filed on Oct. 4, 2005.
(60) Provisional application No. 60/723,424, filed on Oct. 4, 2005.
(60) Provisional application No. 60/723,425, filed on Oct. 4, 2005.

(51) Int. Cl. G06Q 30/00

(52) U.S. Cl. 705/26

(57) ABSTRACT

A computerized service for commerce in digital media in a peer-to-peer network having client modules, controlled by service members, that intercommunicate in the network, locally store digital media container (DMC) files encapsulating digital media works, and deliver DMC file to other client modules via the network. A service module communicates with the client modules via the network to store member information for the client modules, store file information for the DMC files, accept purchase payments for DMC files purchased with the client modules, and credit royalty and/or commission accounts with portions of each purchase payment, wherein the royalty accounts belong to members of the service who are publishers of the DMC files and the commission accounts belong to members of the service who are distributors of the DMC files.

### CROSS-REFERENCE TO RELATED APPLICATIONS

This application claims the benefit of U.S. Provisional Application No. 60/723,423, filed 4 Oct. 2005, U.S. Provisional Application No. 60/723,424, filed 4 Oct. 2005, and U.S. Provisional Application No. 60/723,425, filed 4 Oct. 2005, all hereby incorporated by reference in their entirety.

### TECHNICAL FIELD

The present invention relates generally to generally to peer-to-peer networks, and more particularly to electronic commerce of digital media in such a network that involves any or all of accruing royalties for digital media files for artists, publishers, or rights holders and accruing commissions for distributors of the digital media.

### BACKGROUND ART

Peer-to-peer (P2P) networks have been in use for many years, currently being used widely by organizations like Applejuice network, Avalanche, BitTorrent network, CAKE network, Direct Connect Network, eDonkey network, FastTrack network, FotoSwap network, Freenet network, Gnutella, Gnutella2 network, HyperCast network, Kad network (using Kademila protocol) LUSerNet (using LUSerNet protocol), MANOLITO/MP2P network, Napster network, TVP2P networks, WPNP networks, and many others.

A major problem with such conventional P2P networks, however, is that most have no mechanism to sell copies of the digital media that they distribute, and much of the digital media actually distributed today in such P2P networks is therefore pirated. This overall problem of P2P network sales can be termed the “electronic commerce problem” and a number of factors contribute to it.

For example, two major factors here can be termed the “royalties problem” and the “commissions problem.” Most P2P networks today have no means to compensate members who publish original, copyrightable, digital material with royalties that are redeemable as cash. This is the royalties problem. Similarly, P2P networks today generally have no way to compensate distributors for the use of their computing power to distribute media to others during sales transactions, or if compensation is provided it is not in a form redeemable as cash. This is the commissions problem.

Of course, the electronic commerce problem also has other, lesser sub-problems. These include, without limitation, pricing the digital media to be distributed; ranking or rating the digital media to assist consumers in selection and to ensure their satisfaction and repeat business; and deriving a revenue stream to support and hopefully profit from operation of the P2P network.

Turning now specifically to the royalties problem, there are many P2P networks for exchanging digital media today where no royalties are paid. The only exception known to the present inventor is SnowCap, which is endeavoring to change this but which is limited in that all digital media files it offers are routed through it, imposing a bottleneck and undermining the very advantages of using a P2P network. Thus, P2P networks historically have been used largely to distribute either non-pirated digital media that is usually limited in quantity and quality, or to distribute pirated copies of digital media.

Obviously, potential sources of non-pirated digital media digital media usually have no incentive to provide it, to work to improve its quality, or to allow its distribution. Pirated digital media has therefore been the staple commodity available in P2P networks today. However, these P2P networks are increasingly facing legal measures that are forcing many to remove pirated material, forcing their principal operators to cease operation, or even seeking civil and criminal sanctions against members who receive or distribute the pirated copies.

It follows that what is particularly needed is an incentive mechanism to induce the sources of digital media to provide it and to allow for its distribution. For example, the paying of royalties.

Various methods for accruing royalties on Internet sales have been in use for years. For instance, royalties may be accrued when a store web site, such as the Apple iTunes Store™, allows a user to buy a digital product and download it to their computer, or when a publisher web site allows a user to buy a digital product and download it. Unfortunately, a serious problem with such conventional approaches for accruing and paying royalties is that they reward artists very little or not at all. That is, they do not provide an effective incentive mechanism to reward the actual sources of digital media.

A “traditional model” is generally still used for most digital media sold on the Internet today, wherein individual artists essentially have to sell or license their work to intermediaries who collect, group, and resell or publish it. Unless an artist is in very strong demand, and not already tied up in a contract, they are not in a very strong negotiating position with such intermediaries. This traditional model has historically been justified as necessary to provide economies of scale in media packaging and distribution. With modern technology, however, there is considerably less justification for this because the costs of digital media packaging and distribution can be reduced to near trivial levels. Accordingly, one desirable aspect of solving the royalties problem is to permit artists to be more directly and better rewarded.

This is not to say, however, that the traditional model should be treated as obsolete and that P2P networks can or should eschew dealings with intermediaries and other publishers. First, there already is a huge body or digital media, or subject matter that can be rendered into digital form, that is still controlled by such parties. Furthermore, some portion of new digital media will presumably always be controlled by such parties. For instance, they will likely remain important for finding new talent and cultivating it. Also, some artists simply do not or will not want to handle business matters. Accordingly, another desirable aspect of solving the royalties problem is to continue to permit dealings with intermediaries and other publishers, and to hopefully make such dealings even more secure and efficient.

Turning now specifically to the commissions problem, there are also many networks today where no commissions are paid for distributing digital media. Obviously, these suffer from lack of incentive issues similar to those discussed above with respect to the royalties problem.

Various approaches for accruing commissions have also been in use for years. For instance, again, the iTunes Store™. A major problem here, however, is that distribution tends to be limited to conventional channels, either off-line ones or ones controlled by large distributors that use traditional server-centric networks, and that are only just now getting involved in Internet distribution of digital media. The overhead of accruing commissions tends to motivate the large distributors to limit the number of parties that they pay commissions to, and the result then is that the available selection is generally limited to what is popular. Digital media with small or select audiences accordingly has a difficult time finding a market. There has heretofore been no practical way that an average person can get involved in distributing artists' music or authors' eBooks, so lesser known artists are again left in a poor bargaining position with large recording companies and publishers, and potential consumers for the works of such artists are not exposed to or able to purchase such works.

P2P networks have a number of advantages that can help with distribution of digital media. For instance, they have the ability to distribute digital media content across the “pseudo servers” of large numbers of peers. Entire digital media files can then be stored on, and made available from, any of multiple such peers, potentially at multiple locations in the network. Or fractional parts of digital media files can be made available this way, with the files reassembled into copies of the original digital media work at their end destinations. In P2P networks bottlenecks can be avoided and availability and reliability to be increased when distributing copies of digital media. Unfortunately, however, the P2P networks for digital media distribution to date have not seriously addressed the royalties and commissions problems, and thus remain wanting as solutions to the electronic commerce problem.

### DISCLOSURE OF INVENTION

Accordingly, it is an object of the present invention to provide a digital media commerce service that operates in a peer-to-peer (P2P) network.

Briefly, one preferred embodiment of the present invention is a computerized service for commerce in digital media in a P2P network where client modules, each reside in client systems controlled by members of the service, intercommunicate in the P2P network, locally store one or more digital media container (DMC) files that encapsulate at least a portion of a digital media work, and deliver partial or full copies of the DMC files to other client modules via the P2P network. A service module, residing in a service system controlled by an operator of the service, communicates with the client modules via the P2P network, stores member information associated with the client modules, stores file information associated with the DMC files, accepts purchase payments for instances of the DMC files purchased with the client modules, and credits royalty and/or commission accounts with a portion of each purchase payment, wherein the royalty accounts belong to members of the service who are publishers of the DMC files and the commission accounts belong to members of the service who are distributors of the DMC files.

Briefly, another preferred embodiment of the present invention is a process for members of a service to engage in commerce in digital media in a P2P network. In client systems controlled by the members, one or more DMC files encapsulating at least a portion of a digital media work are stored locally and partial or full copies of the DMC files are delivered to other of the members via the P2P network. In a service system, member information associated with the members and file information associated with the DMC files is stored, purchase payments for instances of the DMC files purchased by the members are accepted, and royalty and/or commission accounts are credited with a portion of each purchase payment, wherein the royalty accounts belong to members who are publishers of the DMC files and the commission accounts belong to members who are distributors of the DMC files.

Briefly, another preferred embodiment of the present invention is a client module for members of a computerized service to engage in commerce in digital media in a P2P network having a service module that communicates with the client module via the P2P network, that stores member information associated with the client modules, that stores file information associated with DMC files that each encapsulate at least a portion of a digital media work, that accepts purchase payments for DMC files purchased with the client module, and that credits royalty and/or commission accounts with a portion of each purchase payment, wherein the royalty accounts belong to members of the service who are publishers of the DMC files and the commission accounts belong to members of the service who are distributors of the DMC files. The client module which constitutes this preferred embodiment of the invention resides in a client system controlled by the member, intercommunicates with other of client modules in the P2P network, stores one or more of the DMC files locally, and delivers partial or full copies of the DMC files to other client modules via the P2P network.

Briefly, another preferred embodiment of the present invention is a service module for a computerized service for commerce in digital media in a P2P network having a plurality of client modules, each residing in client systems controlled by members of the service, that intercommunicate in the P2P network, that store one or more DMC files locally that each encapsulate at least a portion of a digital media work, and that deliver partial or full copies of the DMC files to other client modules via the P2P network. The service module which constitutes this preferred embodiment of the invention resides in a service system controlled by an operator of the service, communicates with the client modules via the P2P network, stores member information associated with the client modules, stores file information associated with the DMC files, accepts purchase payments for DMC files purchased with the client modules, and credits royalty and/or commission accounts with a portion of each purchase payment, wherein the royalty accounts belong to members of the service who are publishers of the DMC files and the commission accounts belong to members of the service who are distributors of the DMC files.

An advantage of the present invention is that it provides a system for digital media commerce in a peer-to-peer (P2P) network.

Another advantage of the invention is that it provides such a system that gives a publisher who creates digital media the ability to sell their digital media works via a P2P network.

Another advantage of the invention is that it provides such a system that compensates members whose computers store and distribute the digital media to other members.

Another advantage of the invention is that it provides a system for accruing royalties in a P2P network for a publisher, artist or rights holder in digital media (collectively “publishers).

Another advantage of the invention is that it provides such a system that allows the publishers themselves to register digital media works for sale and to set royalty rates.

Another advantage of the invention is that it provides such a system that accrues royalties in the publishers' accounts on each P2P digital media sale.

Another advantage of the invention is that it provides such a system that allows the publishers to withdraw funds from their accounts after a fixed level is reached.

Another advantage of the invention is that it provides a system for accruing commissions in a P2P network.

Another advantage of the invention is that it provides such a system that allows ordinary computer users to become distributors of digital media over the Internet.

Another advantage of the invention is that it provides such a system that allows the average person with a broadband connection to a global communication network, such as the Internet, to become a distributor of digital media.

Another advantage of the invention is that it provides such a system that can compute commissions for distributors based on a royalty amount paid to the publisher, a flat rate, media size, or any other metric or combination thereof.

And another advantage of the invention is that it provides such a system that can allocate portions of computed commission to multiple distributors, if more than one is involved in delivering a digital media work.

These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE DRAWINGS

The purposes and advantages of the present invention will be apparent from the following detailed description in conjunction with the appended figures of drawings in which:

FIG. 1 is a block diagram showing the major elements of a digital media commerce service in accord with the present invention;

FIG. 2 is a block diagram showing a partial media registration scenario and a partial media transaction scenario that may be used by the present invention;

FIG. 3 is a flow chart summarizing a royalties accrual process that is in accord with the present invention; and

FIG. 4 is a flow chart summarizing a commissions accrual process that is in accord with the present invention.

In the various figures of the drawings, like references are used to denote like or similar elements or steps.

### BEST MODE FOR CARRYING OUT THE INVENTION

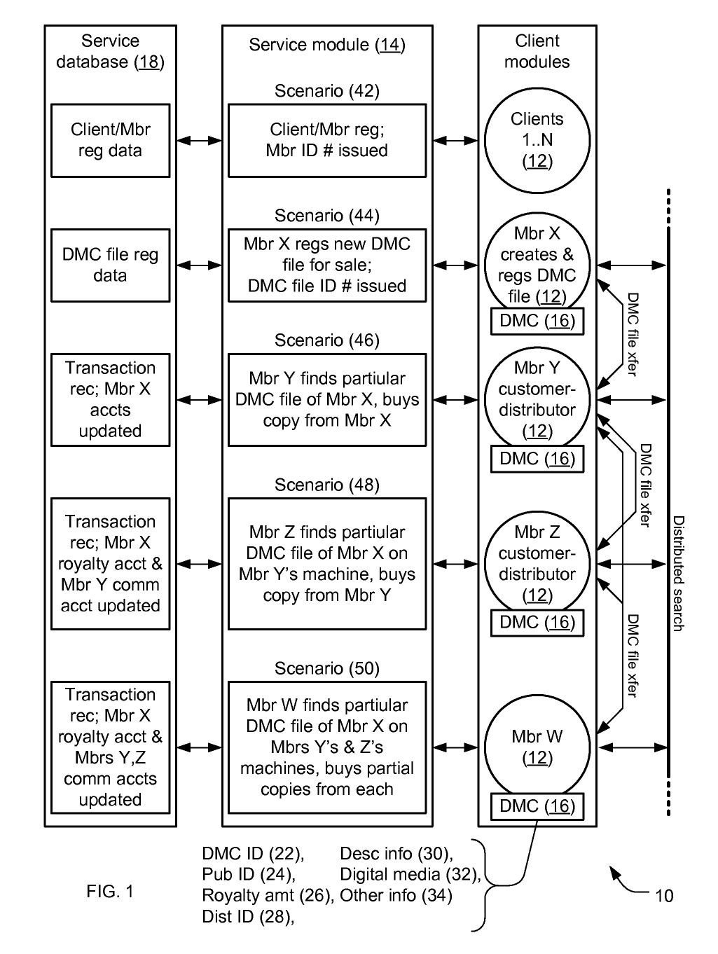

A preferred embodiment of the present invention is a digital media commerce service that operates in a peer-to-peer (P2P) network. As illustrated in the various drawings herein, and particularly in the view of FIG. 1, preferred embodiments of the invention are depicted by the general reference character 10.

FIG. 1 is a block diagram showing the major elements of a digital media commerce service (service 10) in accord with the present invention. The service 10 generally comprises P2P networking software embodied in client modules 12 and a service module 14. A client module 12 resides on each member's client computer, where it particularly works to create and handle digital media container files (DMC files 16). The service module 14 resides on an operator's server computer, where it closely works with a service database 18.

For the sake of this discussion, customers are parties who obtain copies of digital media for their own use; publishers are artists, traditional publishers, or other rights holders who provide the digital media; and distributors are those who directly distribute or facilitate in the distribution of copies of the digital media. As will become apparent, however, distinctions between these parties can blur and the roles can change very easily. In fact, one of the principal advantages of the inventive service 10 is that it can leverage P2P network technology to encourage this, for instance, to permit customers to become distributors and even publishers. In general, the customers, publishers, and distributors of digital media within the service 10 are therefore collectively termed “members.”

As already noted, a client module 12 resides on each member's computer. The customers, publishers, and distributors all may use client modules 12 that are the same, although this is not a requirement and it is possible to construct alternate embodiments of the service 10 employing different client modules 12. For example, the client modules 12 may vary with respect to functional equivalency due to versions, language, currency, operating system, and computer hardware, as long as P2P network interoperability is maintained.

Mechanisms for a member to obtain a client module 12 and to install it on their computer may be entirely conventional. For example, a member may install a copy from a CD, which in turn can be obtained in any of various ways. Alternately, they can download a copy from a web site, which may or may not be directly provided by the operator of the service 10.

Each client module 12 has the capability to create DMC files 16, to compute the pricing of DMC files 16 based on parameters received from the service module 14, to store DMC files 16 in a designated area on the local computer or network (e.g., folder, directory, database, etc.), to respond to queries about the DMC files 16 that it is hosting, to transfer portions or entire DMC files 16 to the client modules 12 on other member's computers, to search for DMC files 16, to receive portions or entire DMC files 16 from the client modules 12 on other member's computers, and to extract digital media from the DMC files 16.

A client module 12 communicates with other client modules 12 to sell copies of DMC files 16 that it has created (i.e., to act as a publisher-member) or otherwise obtained (i.e., to act as a distributor-member), and a client module 12 communicates with other client modules 12 to locate, download, and purchase DMC files 16 (i.e., to act as a customer-member) and thus obtain copies of digital media that are containerized therein (described in more detail presently).

A client module 12 communicates with the service module 14 to register as a member of the service 10, to register DMC files 16 for sale within the service 10, to request directions to one or more locations of peers (other client modules 12) hosting DMC files 16, to make payments for DMC files 16, to send information detailing the member identification numbers of publishers and distributors associated with DMC files 16, and to receive authorization to release digital media from the DMC files 16.

A client module 12 can register its member with the service module 14 as any or all of a customer-member, a publisher-member, and/or a distributor-member. In the course of this the client module 12 receives a member identification number or numbers. As few as one member identification number can suffice, and be used for a member in all of their potential roles as a customer-member, a publisher-member, and a distributor-member. Alternately, variants of the member identification number can be used to identify a member when they are acting as a publisher-member or a distributor-member. Or entirely different member identification numbers can be issued to identify members in their respective roles.

Similarly, where its member is a publisher-member or a distributor-member, a client module 12 can register particular DMC files 16 with the service module 14. In the course of this the client module 12 will provide and receive back various information from the service module 14. For example, if the client module 12 is working with a new DMC file 16 for a publisher-member, it will provide royalty information to the service module 14 and receive back a DMC identification code. If the client module 12 is working with an existing DMC file 16 for a distributor-member, the client module 12 will provide the DMC identification code for that particular DMC file 16 to the service module 14 and will receive back (as noted already) parameters to locally compute pricing of the DMC file 16 or receive parameters from the service module 14 when started. In the inventive service 10, a publisher may lower or raise royalties to change the price of the DMC files they publish, and a distributor may cut his or her distribution share to reduce prices.

The DMC files 16 containerize digital media. They can be made a number of ways and can have their contents arranged in any desired order, but it is anticipated that most embodiments of the service 10 will adopt a standard. FIG. 1 depicts a set of exemplary contents of a DMC file 16, including a DMC identification code 22, one or more publisher identification numbers 24 (e.g., a member identification number of the publisher-member), a royalty amount 26, one or more distributor identification numbers 28 (e.g., member identification numbers of distributor-members), descriptive information 30, the digital media 32 (typically embodied in one or more files), and any desired other information 34.

Typically, but not necessarily, a DMC file 16 will have only one publisher and thus include only one publisher identification number 24. If a DMC file 16 has more than one publisher it can potentially include multiple royalty amounts 26, but this is not necessary since the service module 14 can access information to apportion royalties from a single gross royalty amount 26.

Including any distributor identification numbers 28 in a DMC file 16 is optional, but it can be useful to track the distribution history of particular DMC files 16 to help analyze how the service 10 is working, to detect pirated or hacked instances of DMC files 16, and to assure publishers of the DMC files 16 that the service 10 can employ affirmative measures to suppress the pirating or hacking of DMC files 16.

The descriptive information 30 in a DMC file 16 can range considerably in type and detail. It typically will include a title and a file type for the digital media 32, and often a preview of the digital media 32, but beyond this the nature of the digital media 32 will largely influence the content of the descriptive information 30. For example, if the digital media 32 is an AVI format video file the descriptive information 30 may list the audio and video CODECs required for playback. Alternately, however, those CODECs may be widely used and available, and listing them might merely serve to confuse potential customers. In any case, the contents of the descriptive information 30 will usually be straightforward and skilled technicians and programmers creating or configuring embodiments of the inventive service 10 should be able to set requirements or guidelines as needed.

The digital media 32 in a DMC file 16 may or may not be protected against unauthorized access. As discussed elsewhere herein, for instance, some embodiments of the service 10 can require authorization, typically but not necessarily, based on a payment confirmation before a customer-member can even download a DMC file 16 from the client module 12 of a publisher-member or distributor-member. In these embodiments additional protection can be dispensed with, or not. In other embodiments a “strong” protection can be applied to the digital media 32. For example, it may be encrypted, wherein an authorization provided by the service module 14 to access it can include a decryption key. Or the digital media 32 can be scrambled, say, by inverting the bits in every other byte, and the client module 12 can be set to unscramble the digital media 32 only based on an authorization. In any case, here as well, crafting and configuring embodiments of the inventive service 10 as desired for this should usually be straightforward for skilled technicians and programmers.

Finally, a DMC file 16 may include other information 34, for instance, a checksum to permit verifying the integrity of the a DMC file 16. Embodiments of the service 10 where sub-portions of the digital medial 32 in a DMC file 16 can be distributed (described presently) may also have information stored here to facilitate this.

The service module 14 communicates with the client modules 12 and the service database 18 (described in detail presently). As already noted, this entails handling registration of the client modules 12 (members), handling registration of the DMC files 16, authorizing extraction of the digital media 32 from the DMC files 16 (upon payment confirmation or for other reasons, such as promotional or review uses), and (optionally) assisting members to locate particular DMC files 16.

The service module 14 also can apply different formulations for pricing the digital media 32 based on the royalties set by publisher-members and other factors, and it can send pricing rules and parameters to the client modules 12, as they initially join the service 10, as they regularly connect to the P2P network, and as generally desired.

Another major role or the service module 14 is to handle payment and accounting transactions. These include receiving payments from the client modules 12 for purchased DMC files 16, and optionally receiving payments from the client modules 12 for registering DMC files 16, if the particular embodiment of the service 10 requires such. The service module 14 also handles crediting a publisher's royalty account (typically in proportion to their interest in a DMC file 16) and crediting a distributor's commission account (typically in proportion to the amount of a digital media work or even the sub-portion of a DMC file 16 that they delivered). The service module 14 can also handle receiving requests for payout of accrued royalties or commissions, and sending checks to those members that have accrued royalties or commissions over a certain amount.

The service database 18 stores registration information for the members of the service 10, including the member identification number (or numbers), name, password, mailing address, and any other desired member-specific information. It also stores registration information for the DMC files 16, including title, author, category, genre, description, royalty, format, size, and any other desired media-specific information. This is also where accounting transaction information is kept with respect to member activities and the transactions in the DMC files 16, including accrued royalties, distributed royalties, accrued commissions, distributed commissions, and any other desirable account information. Additionally, the service database 18 may be used to store information to generate statistics for particular members, products, and/or services.

FIG. 1 also illustrates some common scenarios in the service 10. In an initial sign up scenario 42 a member uses a client module 12 to contact the service module 14 and register with the service 10. As part of the sign up process, the member will typically provide an e-mail address and a password to the service module 14, and will receive a member identification number back from the service module 14. The service module 14 will store this information in the service database 18, and will also usually go ahead and create royalty and commission accounts associated with the member identification number and that have zero initial balances. Note, embodiments of the inventive service 10 can also use just one combined royalty/commission account per member, but separate accounts are described in the examples herein.

Also shown in FIG. 1, in a media registration scenario 44, a publisher-member uses their client module 12 to register a DMC file 16 with the service module 14 for distribution by the service 10. The member, “Member X” here, decides to sell a digital media file that they have created or otherwise obtained and have the right to sell. Using their client module 12, Member X creates a DMC file 16 that contains the unique DMC identification code 22, the publisher identification number 24 (e.g., their member identification number), the royalty amount 26, the descriptive information 30 about the digital media (e.g., file size, an optional preview portion, and any other useful descriptive information), and the digital media 32 itself. Member X then uses their client module 12 to communicate the DMC identification code 22, the publisher identification number 24, the royalty amount 26, and (optionally) some or all of the descriptive information 30 to the service module 14. Upon receipt of this the service module 14 places all of this information into the service database 18. The DMC file 16 held by Member X is now formally registered within the service 10.

Further shown in FIG. 1, in a transaction scenario 46, a “Member Y” acts as a customer-member and then becomes a distributor-member. Contacting the service module 14, Member Y searches for digital media in accord with his or her interests and determines that the DMC file 16 held by Member X is a candidate. Based on this, Member Y requests the DMC file 16 from Member X and a copy is transferred to Member Y. Member Y then uses their client module 12 to make a payment to the service module 14, and once that clears the service module 14 responds back with a payment confirmation and authorization to access the digital media 32. Contemporaneously, the service module 14 credits the royalty account of Member X and records details about this now completed sales transaction in the service database 18. Member Y is now free to extract and use the digital media 32 from the DMC file 16.

However, here Member Y can and does do more. Member Y additionally becomes a distributor-member and makes their copy of the DMC file 16 available for redistribution. Member Y uses their client module 12 to register its instance of the DMC file 16 of Member X with the service module 14, effectively asking to make it known within the service 10 that it is now a distributor for Member X's DMC file 16. In the course of this Member Y's client module 12 may “repackage” the original DMC file 16 somewhat. For example, they can add their distributor identification number 28 replacing another distributor identification number 28 or appending theirs to a list of other distributor identification numbers 28. This feature is optional, and generally will be set by the operator of the service 10 rather than individually by members. If all is proper, the service module 14 updates the service database 18 accordingly, the DMC file 16 held by Member Y is registered within the service 10, and Member Y is now a distributor-member.

Next shown in FIG. 1, in another transaction scenario 48, a “Member Z” also acts as a customer-member and also becomes a distributor-member. Contacting the service module 14, Member Z also looks for and finds that the DMC file 16 initially supplied by Member X is on the machine of Member Y. Member Z buys a copy of the DMC file 16 and also puts this copy up for redistribution from their machine. Again the transaction is recorded by the service module 14 in the service database 18. In this case, however, the royalty account of Member X is credited, the commissions account of Member Y is credited, and details for these results are recorded in the service database 18.

Finally shown in FIG. 1, in a different transaction scenario 50, yet another member, “Member W,” searches out the same DMC file 16 and finds it on the machines of both Member Y and Member Z. Member W then buys a copy of the DMC file 16 from both Member Y and Member Z. Again the transaction is recorded in the service database 18 by the service module 14. As before, a royalty portion is credited to the royalty account of Member X. The commission portion, however, is split between Members Y and Members Z in proportion to the amount of the DMC file 16 delivered by each. The service module 14 therefore credits the commission accounts for both Member Y and Member Z and records this in the service database 18.

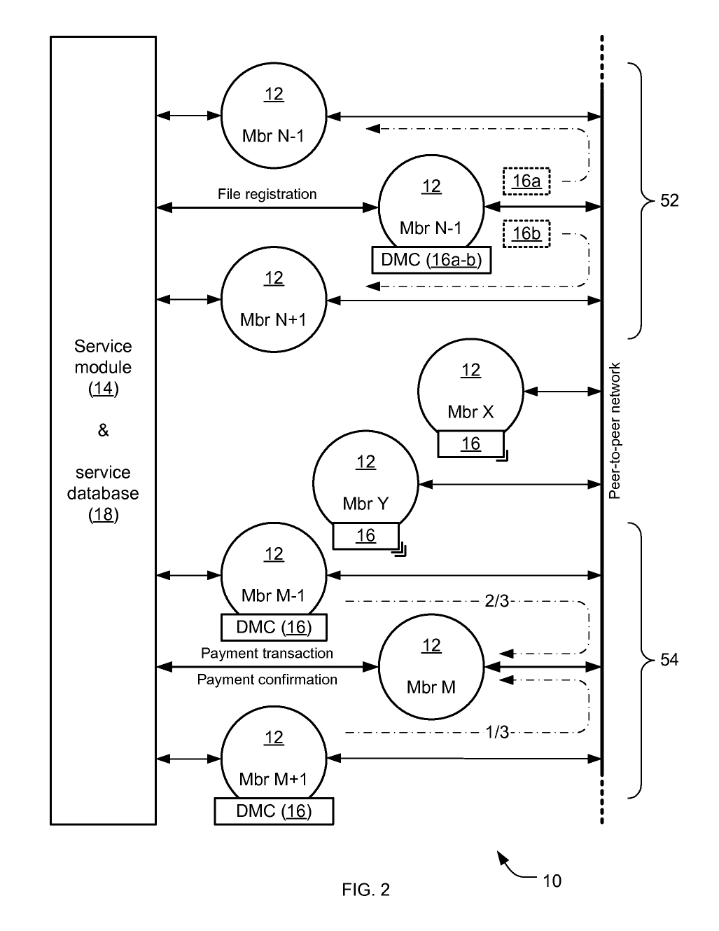

FIG. 2 is a block diagram showing a partial media registration scenario 52 and a partial media transaction scenario 54. These cases particularly illustrate how the service 10 can leverage P2P technology to very efficiently host and distribute digital media, including quite large instances.

In the partial media registration scenario 52 a Member N uses their client module 12 to create two DMC files 16a-b which respectively each contain portions that are collectively needed to reconstruct one digital media file that Member N started with. Member N sends DMC file 16a to Member N−1 and sends DMC file 16b to Member N+1.

A variety of mechanisms can guide how the DMC files 16a-b are distributed. For instance, Member N can also register both DMC files 16a-b with the service module 14, and it can instruct Member N where to send them or it can instruct Members N−1 and N+1 to request them. Or Member N can have a list of “neighboring” distributor-members that the service module 14 previously provided. Or Member N can wait for requests from Members N−1 and N+1, because the service module 14 has previously provided them with a list of “neighboring” potential publisher-members they should periodically poll when looking for DMC files 16 to host as distributor-members. Or Member N and Members N−1 and N+1 may simply have had some past dealings and Member N can contact Members N−1 and N+1 directly.

In any case, once Members N−1 and N+1 now each have one of DMC files 16a-b, respectively, and they register them with the service module 14. Optionally, Member N can now delete his or her copies of DMC files 16a-b, say, after receiving feedback from the service module 14 that copies are now lodged with distributor-members. Note, Member N presumably still has the original digital media that the DMC files 16a-b are based on, so they should be able recreate any or all of DMC files 16a-b.

All of the DMC files 16a-b are now hosted on different clients in the P2P network and are registered by the service module 14. Of course, this is easily extendable to more than just two distributor-members—potentially to tens, hundreds, or more.

In general, presently preferred embodiments of the service 10 do not employ multiple DMC files 16 for single digital media works. Rather, as described next, preferred embodiments employ a single DMC file 16 for each digital media work and, optionally, permit distribution to customer-members of portions of the digital media 32 in such a DMC file 16 from multiple copies of the DMC file 16 that are dispersed in the P2P network. The client module 12 of the customer-member can then assemble the digital media 32 from the portions.

FIG. 2 also shows the partial media transaction scenario 54. Here a Member M needs a full copy of a DMC file 16 (i.e., Member M's goal is to obtain a full copy of the digital media 32 in the DMC file 16). By any of various possible search means, Member M's client module 12 determines that Members M−1 and M+1 both have copies of the desired DMC file 16, and it proceeds to download portions of the DMC file 16 from the client modules 12 of both Members M−1 and M+1. For the sake of example, lets say that two-thirds (⅔) of the DMC file 16 is copied from Member M−1 and the other one-third (⅓) is copied from Member M+1. The client modules 12 can hide all of the underlying technical details for this from the members, although distributor-members will typically want to know the proportion of the DMC file 16 that they distributed and should be compensated for.

Once Member M has the full DMC file 16, they need authorization from the service module 14 before the digital media 32 can be extracted. Member M therefore has their client module 12 contact the service module 14 to get this, typically in exchange for a payment. In the course of this, Member M's client module 12 informs the service module 14 that Member M−1 provided it with ⅔ of the DMC file 16 and that Member M+1 provided it with ⅓ of the DMC file 16 (which the service module 14 will use to credit Members M−1 and M+1 accordingly). And if all is in order, the service module 14 provides the authorization and Member M's client module 12 then extracts the digital media 32 and Member M can now generally do with it as they please.

As can be appreciated form the preceding, the inventive digital media commerce service 10 is particularly distinguishable over prior art P2P networks in that it permits publisher-members and distributor-members to be reasonably compensated. We now turn to discussions of the royalties accrual and pay out and of the commissions accrual and pay out features of the inventive service 10.

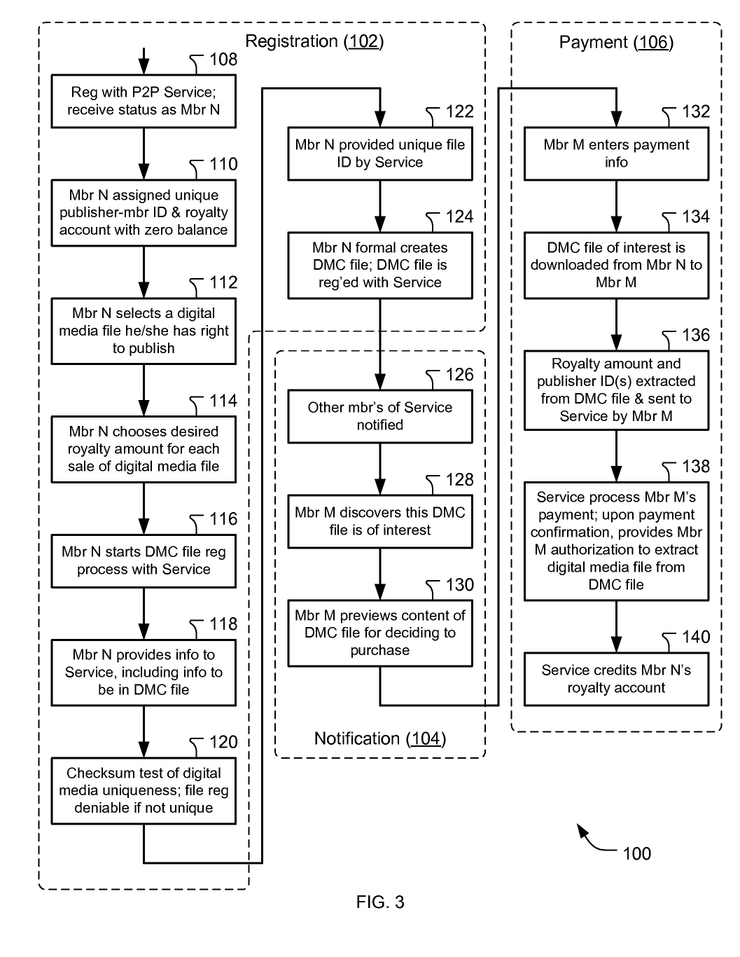

FIG. 3 is a flow chart summarizing a royalties accrual process 100 that is in accord with the present invention. The royalties accrual process 100 has three major stages: a registration stage 102, a notification stage 104, and a payment stage 106.

Briefly, in the registration stage 102 a publisher registers a DMC file 16. In the notification stage 104 other members of the service 10 are notified of the existence of the registered DMC file 16, and potential customers are optionally allowed to sample the content of the DMC file 16. And in the payment stage 106 transfer of the full DMC file 16 to the customers occurs, payment is accepted from customers, payments are confirmed, release of the digital media for use by the customers is authorized, and royalty amounts are formally accrued to the publisher.

Starting with the registration stage 102, it has already been noted that there are two types of registration: member registration and digital media file registration. In order to become a member of the P2P network one must register with the service 10. This is done by downloading the client module 12 and through it supplying an email address, password and other such information useful to the service 10. On acceptance of the registration data the new member is assigned a unique identifier, a royalty account, and a commissions account. Only members of the service 10 can participate in the network P2P transactions.

Accordingly, member registration in FIG. 3 starts in a step 108, where a person uses a client module 12 to contact the service module 14 and is given status as a new member (“Member N”) in the service 10. In a step 110 Member N is assigned a unique identity (i.e., their publisher identification number 24) and a royalty account for them is created in the service database 18. Typically, the balance in this account will be initially set to zero. Member registration here ends with step 110.

After becoming a member, one can become a publisher by registering one or more digital media files. Any member can select files they want to sell to other members of the service 10, as long as they hold rights permitting them to sell the file. The publisher-member chooses a royalty amount to be accrued every time their file is delivered to and sold to another member of the service 10. Then the publisher-member contacts the service module 14 to register their digital media file, supplying the chosen royalty amount and other information. The service module 14 then returns information about the publisher-member, all or most of which can be incorporated into the DMC file 16 that the member's client module creates. For example, the royalty amount requested by the member may be increased and communicated back as a higher amount where the difference goes to compensating the operator of the service 10. Alternately, embodiments of the service 10 are envisioned where the operator derives compensation only from distributor transactions or from advertising or other means that are not tied to the royalties or commissions. Here the service 10 may or may not set a floor and/or ceiling on the royalty amount (and the commission amount).

Accordingly, digital media file registration in FIG. 3 starts in a step 112, where Member N selects a digital media file that they have the right to sell. In a step 114 Member N chooses a royalty amount that they wish to be paid for each sale of their media file. In a step 116 Member N initiates a media registration dialog with the service module 14. In a step 118 Member N provides the chosen royalty amount and descriptive information about the media file. Typically, this descriptive information will be encapsulated in the DMC file 16 as the descriptive information 30 there, but it is not a requirement that all or even any of the information provided here be used for that.

Optionally, in a step 120 the service module 14 can check Member N's digital media file for uniqueness, based on a checksum Member N's client module 12 can provide and checksums for other files (e.g., for other, already registered DMC files 16 or for digital media that is known to be pirated, illegal, inappropriate, etc.). Registration Member N's media file can be denied if its checksum is not unique.

In a step 122, Member N is provided with a unique media identification number. Generally, this will be used as the DMC identification code 22 when the DMC file 16 is produced.

Finally, in a step 124 the DMC file 16 is produced by Member N's client module 12. Digital media file registration and the registration stage 102 here end with step 124.

Once the client module 12 is finished creating a DMC file 16 with the information required by the service 10, other members need to become aware of its existence. Some portion of or all of the members may therefore be affirmatively notified by the service module 14. At this point the DMC file 16 also can be discovered by the members through various other methods, such as a P2P search. When a potential customer-member (or distributor-member) finds the desired file it may or may not be previewed.

Accordingly, the notification stage 104 in FIG. 3 starts in a step 126, where other members of the service 10 are notified of the existence of Member N's DMC file 16. Various approaches can be used for this, individually or in combination. For example, the service module 14 can inform the client modules 12 of the other members of this. Or the client modules 12 of the other members can query the service module 14 about new members or new DMC files 16. In presently preferred embodiments of the service 10, however, the advantages of P2P technology are used to accomplish this notification. A set of other members of the service 10 are notified of the existence of new Member N and the members can then use P2P searches.

In a step 128 a Member M discovers that Member N's DMC file 16 is of interest. In the preferred embodiments of the service 10, Member M uses key words to search their list of members, and the client modules 12 of those members in turn search their lists of members, and so on. For each matching DMC file 16, Member M receives back a location (e.g., the hosting distributor-member's IP address), a title of the digital media work, etc. In an optional step 130 Member M can preview the content of the DMC file 16. Various mechanisms can be used to permit this. For example, previews can be portions of or low-quality versions of the actual digital media 32 in the DMC file 16. A preview can be posted separate from the DMC file 16, with a link to where it is, or it can be posted with the DMC file 16. Typically, a preview is included in the descriptive information 30 in the DMC file 16. The notification stage 104 here ends with step 130.

If a member decides to purchase the DMC file 16, they enter payment information and download the DMC file 16 via their client module 12. The DMC file 16 may or may not be verified once downloaded. At this point the DMC file 16, usually, is still encapsulated and its digital media 32 cannot be used by the member yet. The payment stage 106 can be generally conventional, except that the client module 12 of the customer-member communicates the payment to the service module 14 rather than to the client module 12 of the publisher or a distributor. The DMC identification code 22 and the royalty amount 26 in the DMC file 16 are extracted and sent along with the customer-member's payment to the service module 14. The service module 14 then processes the payment, and confirms receipt of it to the customer-member's client module 12. This confirmation includes an authorization (decryption key, etc., as needed) permitting the customer-member to extract the digital media 32 from the DMC file 16. Various usage rules may still apply to the extracted digital media 32 restricting its use, such as contractual limitations similar to those in many software profucts. Essentially contemporaneous with sending the confirmation, the service module 14 credits the royalty account of the publisher-member.

Accordingly, the payment stage 106 in FIG. 3 starts in a step 132, where Member M provides payment information to the service module 14 for Member N's DMC file 16. In a step 134, Member M downloads the DMC file 16 from Member N's client module 12. Note, in alternate scenarios Member M can download the DMC file 16 earlier, even before step 128 in the notification stage 104. In embodiments of the service 10 where this is permitted, the DMC files 16 will typically employ a strong mechanism, like encryption, to ensure that members do not extract the digital media 32 without paying or otherwise being authorized to do so.

In a step 136 Member M sends information about the DMC file 16 to the service module 14, typically including the DMC identification code 22, the publisher identification number 24, and the royalty amount 26. Note, if the alternate scenario described above is followed, step 132 and step 136 can be combined.

In a step 138 the service module 14 processes Member M's payment and provides Member M with a payment confirmation (i.e., an authorization, including a decryption key if needed) so the digital media 32 can be extracted from the DMC file 16.

Finally, in a step 140 the service module 14 credits Member N's royalty account based on the now consummated sale of their digital media file to Member M. The payment stage 106 and the royalties accrual process 100 ends here with step 140.

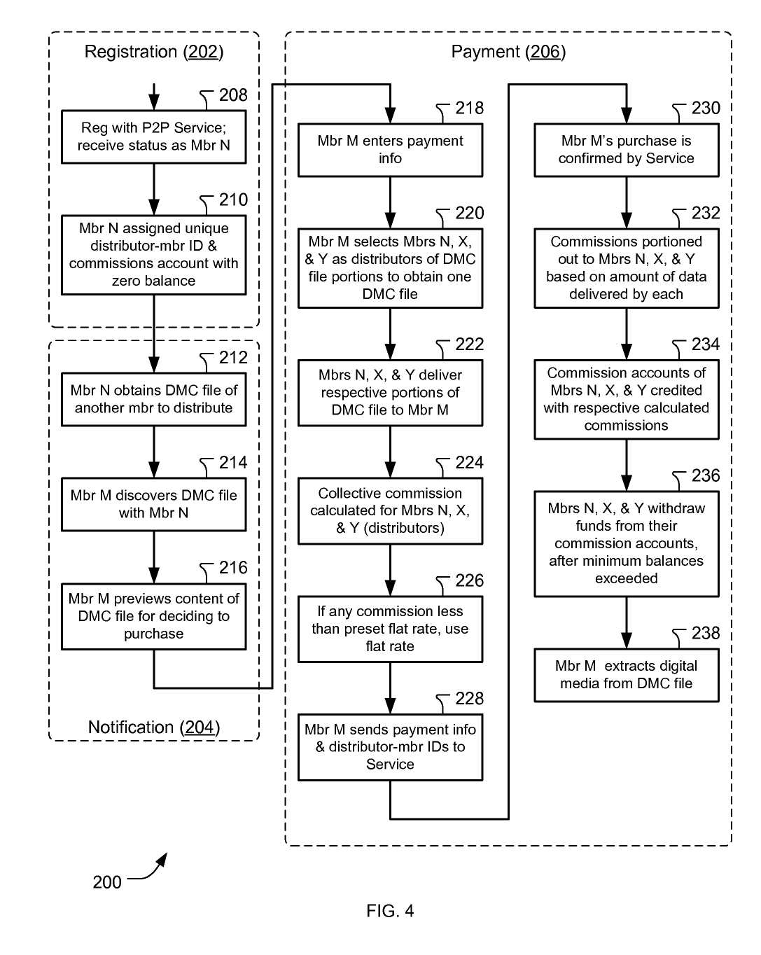

FIG. 4 is a flow chart summarizing a commissions accrual process 200 that is in accord with the present invention. The commissions accrual process 200 also has three major stages: a registration stage 202, a notification stage 204, and a payment stage 206.

Briefly, in the registration stage 202 a distributor registers a DMC file 16. In the notification stage 204 other members of the service 10 are notified of this, and potential customers are optionally allowed to sample the content of the DMC file 16. And in the payment stage 206 transfer of the full DMC file 16 to the customers occurs, payment is accepted from customers, payments are confirmed, releases of the digital media for use by the customers are authorized, and commissions amounts are formally accrued to the distributors.

Starting with the registration stage 202, it has been noted that there are two types of registration: member registration and digital media file registration. In order to become a member of the P2P network one must register with the service 10. This has been described elsewhere herein. Upon acceptance of their registration data a new member is assigned a unique identifier, a royalty account, and a commissions account. Only members of the service 10 can participate in the network P2P transactions, and any member can offer digital media files for sale to other members on the P2P network.

Accordingly, member registration in FIG. 4 starts in a step 208, where a person uses a client module 12 to contact the service module 14 and is given status as a new member (“Member N”) in the service 10. In a step 210 Member N is assigned a unique identity (i.e., their distributor identification number 28) and a commission account for them is created in the service database 18. Typically, the balance in this account will be initially set to zero. Member registration here ends with step 210.

After becoming a member, one can become a distributor by registering one or more digital media files. The digital media files for this can be obtained by any method, including consignment or promotion, purchase, or creation. Since creation is essentially the publisher case, discussed above, it is not discussed further here. It is anticipated that purchase and consignment will be the typical mechanisms by which distributor-members obtain digital media files to sell. Basically, purchase is straightforward and has already been cover in the discussion of the customer-member role. Once a customer-member has purchased a DMC file 16 for their personal use they may optionally also become a distributor-member for that DMC file 16. Consignment or promotion is different in that the distributor-member is not also a customer-member. The distributor-member here has a copy of the DMC file 16 but they do not have the right to make personal use of its contents. In fact, they may not even have the ability to extract the digital media 32 from the DMC file 16. Note, this arrangement works well for large digital media files that are encapsulated in multiple DMC files 16, where a distributor-member hosts less than all of the DMC files 16 necessary to reconstruct an original digital media file. Such a distributor-member may have once even been a customer-member with respect to the subject digital media file, but then erased it or let their license to it lapse, and now is distributing only some of the DMC files 16.

Accordingly, the notification stage 204 in FIG. 4 starts in a step 212, where Member N obtains a DMC file 16 to distribute. In a step 214 a Member M discovers that they are interested in the digital media in the DMC file 16 that Member N has. Various methods can be used to help Member M discover this. For example, Member M can use a P2P search or they can learn this from the service module 14, if it is even aware yet that Member N has opted to become a distributor. Note, once Member N has obtained and decided to distribute the DMC file 16 they can inform the service module 14 of this. But that is not necessary in all embodiments of the inventive service 10. Since the contents of the DMC file 16 will, presumably, only be accessible to potential customer-members after they obtain authorization from the service module 14, there is no technical reason that a member of the service 10 cannot just offer up for sale a DMC file 16 that they possess and the service module 14 can infer that this member has acted as a distributor when it handles the first purchase transaction by a customer-member.

In an optional step 216 Member M can preview the digital media that the DMC file 16 entirely or partially contains. Various mechanisms can be used to permit this (examples are discussed above with step 130 of the royalties accrual process 100). The notification stage 204 here ends with step 216.

The payment stage 206 in FIG. 4 starts in a step 218, where Member M provides initial payment information to the service module 14. In a step 220 Member M selects where it will download the DMC file 16 (or DMC files 16) that contain the digital media file they want. For the sake of example here, Members N, X, and Y will be used as sources for the needed the DMC file 16. In a step 222 the client modules 12 of Members N, X, and Y each deliver portions of the DMC file 16 to the client module 12 of Member M. As discussed elsewhere herein, the DMC file 16 can optionally be verified.

In a step 224 the commissions for the distributor-members (Members N, X, and Y) are calculated. Additional details and options for this are covered below. If the calculated rate for a commission is less than a predetermined flat rate, however, in a step 226 the flat rate is used instead.

In a step 228 the client module 12 of Member M sends the final payment information and a list of the distributor identification numbers 28 and states the respective portions of the DMC file 16 that each delivered.

In a step 230 the service module 14 confirms Member M's purchase and provides authorization for Member M to extract the digital media 32 from the DMC file 16.

In a step 232, typically performed roughly contemporaneous with step 230, the service module 14 calculates how to apportion the commissions to the distributors of the DMC file 16 (Members N, X, and Y). Various formulas can be used for this. In FIG. 4 it is done based on the proportion of the digital media delivered by each distributor. In a step 234 the service module 14 next credits the respective distributor commission accounts accordingly. At some later point, typically after a threshold minimum exists in a commission account, in a step 236 the distributors withdraw funds from their commission accounts.

Finally, in a step 238, Member M does extract the digital media 32 from the DMC file 16 and can use it generally as they wish. However, various usage rules may still be applied that only allow the customer-members to extract and use the digital media files accordingly. For example, the copy obtained may be licensed rather than sold, say, with the license granting the customer-member the right to use the digital media for a set period of time. Or the license may grant use the digital media only for non-commercial purposes.

Note, the sequence of steps 218-238 here in the payment stage 206 may initially seem odd. For example, there is no technical reason that Member M could not download the DMC file 16 in one step, pay for it in a subsequent step, and then receive back the payment confirmation and authorization to access its contents in another step. In some embodiments of the service 10, however, there may legal motivations for using the steps shown in FIG. 4.

Some publishers will hesitate to permit their digital media to be delivered to customers, especially by distributors they may not even know, unless a trusted central party (e.g., the operator of the service 10) has already received a customer payment. One rationale for this is that parties who manage to obtain DMC files and access their contents without paying are not regarded as infringers of a publisher's intellectual property rights under some legal schemes. There may possibly be remaining legal causes of action for fraud or breach of contract under even these legal schemes, but those might not be satisfactory to a publisher because the operator of the service would likely be the only party having standing to pursue such legal actions. In any case, a key point to be taken from this is that the inventive service 10 can be flexibly embodied to deal with technical concerns, legal concerns, and publisher confidence concerns.

There are various ways that a commission may be calculated. For instance, it can be calculated based on the DMC file 16, factoring in the type of data it contains, using an assigned value such as the royalty amount payable to the publisher, or any other metric (e.g., file size), or on some combination of these. Alternately, a flat rate commission can be used for every file. Or, a combination based on a content metric and a flat rate can be used. For example, a flat rate can be used as a minimum commission if a calculated value is less than the flat rate.

While various embodiments have been described above, it should be understood that they have been presented by way of example only, and that the breadth and scope of the invention should not be limited by any of the above described exemplary embodiments, but should instead be defined only in accordance with the following claims and their equivalents.

1. A computerized service for commerce in digital media in a peer-to-peer network, comprising:
a plurality of client modules each residing in client systems controlled by members of the service, wherein said client modules:
intercommunicate in the peer-to-peer network;
store one or more digital media container (DMC) files locally, wherein said DMC files each encapsulate at least a portion of a digital media work; and
deliver partial or full copies of said DMC files to other said client modules via the peer-to-peer network; and
a service module residing in a service system controlled by an operator of the service, wherein said service module:
communicates with said client modules via the peer-to-peer network;
stores member information associated with said plurality of client modules;
stores file information associated with said DMC files;
accepts purchase payments for instances of said DMC files purchased with said client modules; and
credits at least one of the set consisting of royalty accounts and commission accounts with a portion of each said purchase payment, wherein said royalty accounts belong to said members of the service who are publishers of said DMC files and said commission accounts belong to said members of the service who are distributors of said DMC files.

2. The service of claim 1, wherein said client modules:
extract said digital media work from said DMC files based on an authorization from said service module.

3. The service of claim 1, wherein said client modules:
request locations from said service module of other said client module storing other said DMC files, thereby permitting centralized searching for said DMC files within the service.

4. The service of claim 1, wherein said client modules:
respond to queries from other said client modules about their stored said DMC files, thereby permitting peer-to-peer searching for said DMC files within the service.

5. The service of claim 1, wherein said client modules:
create new said DMC files; and
send said file information to said service module, thereby registering said new said DMC files for sale within the service.

6. The service of claim 5, wherein said file information includes:
a publisher's identifier; and
a royalty computed for said new said DMC files.

7. The service of claim 1, wherein said client modules:
request disbursements by said service module of publisher's royalties accrued in said royalty accounts.

8. The service of claim 1, wherein said client modules:
send said file information to said service module for procured said DMC files from other said client modules, thereby registering additional outlets of said DMC files for sale within the service.

9. The service of claim 8, wherein said file information includes:
a distributor's identifier; and
a commission computed for said procured said DMC files.

10. The service of claim 1, wherein said client modules:
request disbursements by said service module of distributor's commissions accrued in said commission accounts.

11. The service of claim 1, wherein each particular said DMC file further includes a DMC identifier uniquely identifying said particular said DMC file and at least one member of the set consisting of a publisher identifier uniquely identifying a said publisher of said particular said DMC file, a royalty due to said publisher of said particular said DMC file for each sale of said particular said DMC file, and a distributor identifier uniquely identifying a said distributor of said particular said DMC file.

12. The service of claim 1, wherein said service module:
sends pricing rules and parameters to said client modules.

13. The service of claim 1, wherein said service module:
accepts registration payments for instances of said DMC files registered in the service with said client modules.

14. The service of claim 1, wherein said service module:
stores said member information, said file information, and transaction accounting information in a database.

15. The service of claim 1, wherein said service module:
credits a said publisher's said royalty account in proportion to their interest in a said DMC file that is sold.

16. The service of claim 1, wherein said service module:
credits a said distributor's said commission account in proportion to a said digital media work in a said part of a said DMC file that said distributor delivered.

17. A process for members of a service to engage in commerce in digital media in a peer-to-peer network, the process comprising:
in client systems controlled by the members:
storing one or more digital media container (DMC) files locally, wherein said DMC files each encapsulate at least a portion of a digital media work;
delivering partial or full copies of said DMC files to other of the members via the peer-to-peer network;
in a service system:
storing member information associated with the members;
storing file information associated with said DMC files;
accepting purchase payments for instances of said DMC files purchased by the members; and
crediting at least one of the set consisting of royalty accounts and commission accounts with a portion of each said purchase payment, wherein said royalty accounts belong to instances of the members who are publishers of said DMC files and said commission accounts belong to instances of the members who are distributors of said DMC files.

18. A client module for members of a computerized service to engage in commerce in digital media in a peer-to-peer network having a service module, residing in a service system controlled by an operator of the service, that:
communicates with the client module via the peer-to-peer network;
stores member information associated with the client modules;
stores file information associated with digital media container (DMC) files, wherein said DMC files each encapsulate at least a portion of a digital media work;
accepts purchase payments for instances of said DMC files purchased with the client module; and
credits at least one of the set consisting of royalty accounts and commission accounts with a portion of each said purchase payment, wherein said royalty accounts belong to the members of the service who are publishers of said DMC files and said commission accounts belong to the members of the service who are distributors of said DMC files;
and wherein the client module:
resides in a client system controlled by the member;
intercommunicates with other of the client modules in the peer-to-peer network;
stores one or more said DMC files locally; and
delivers partial or full copies of said DMC files to other said client modules via the peer-to-peer network.

19. A service module for a computerized service for commerce in digital media in a peer-to-peer network having a plurality of client modules, each residing in client systems controlled by members of the service, that:
intercommunicate in the peer-to-peer network;
store one or more digital media container (DMC) files locally, wherein said DMC files each encapsulate at least a portion of a digital media work; and
deliver partial or full copies of said DMC files to other of the client modules via the peer-to-peer network;
and wherein the service module:
resides in a service system controlled by an operator of the service;
communicates with the client modules via the peer-to-peer network;
stores member information associated with the client modules;
stores file information associated with said DMC files;
accepts purchase payments for instances of said DMC files purchased with the client modules; and
credits at least one member of the set consisting of royalty accounts and commission accounts with a portion of each said purchase payment, wherein said royalty accounts belong to the members of the service who are publishers of said DMC files and said commission accounts belong to the members of the service who are distributors of said DMC files.
